(19) United States
(12) Patent Application Publication
(10) Pub. No.: US 2024/0233011 A9
(43) Pub. Date: Jul. 11, 2024

(54) Method and System for Reduced-Risk Extension of Credit

(71) Applicant: Steven J. Zeringue, Baton Rouge, LA (US)

(72) Inventor: Steven J. Zeringue, Baton Rouge, LA (US)

(21) Appl. No.: 18/218,393

(22) Filed: Jul. 5, 2023

Related U.S. Application Data
(63) Continuation of application No. 17/749,830, filed on May 20, 2022, now abandoned.
Application No. 17/749,830 is a continuation of application No. 15/469,900, filed on Mar. 27, 2017, now abandoned.
Application No. 15/469,900 is a continuation of application No. 14/639,693, filed on Mar. 5, 2015, now abandoned.
Application No. 14/639,693 is a continuation of application No. 13/038,712, filed on Mar. 2, 2011, now abandoned.
(60) Provisional application No. 61/309,740, filed on Mar. 2, 2010.

(51) Int. Cl. G06Q 40/03; G06Q 20/02; G06Q 20/10; G06Q 20/24; G06Q 20/40; G06Q 40/02

(52) U.S. Cl. CPC G06Q 40/03; G06Q 20/027; G06Q 20/10; G06Q 20/24; G06Q 20/40; G06Q 20/4037; G06Q 20/405; G06Q 40/02

(57) ABSTRACT

A system and method for extending a firm offer of credit without regard to the credit risk profile of the credit applicant is disclosed. Using seller-defined and/or system and method provider configured business rules and related payment computations, the system derives a series of initial payments representing a “down payment.” After the down payment is collected, the goods or services are delivered. The purchaser may elect upfront from a plurality of payment options, including the automatic collection through recurring pre-authorized electronic funds transfers to a deposit account or via authorized and settled credit or debit card authorization(s). A purchaser using either of these options has the option, upon receipt of the goods or services, to pay the remaining balance through the continuation of electronic funds transfers or, at any point prior to completion of payments using a “one-time authorized amount for the balance due” alternative form of payment like cash, credit or debit card, to pay off the remaining balance.

### CROSS-REFERENCE TO RELATED APPLICATIONS

The present application claims the benefit of claims the benefit of prior U.S. application Ser. No. 17/749,830 filed May 20, 2022 which claims benefit of U.S. application Ser. No. 15/469,900 filed Mar. 27, 2007 which claims benefit of U.S. application Ser. No. 14/639,693 filed Mar. 5, 2015 which claims benefit of U.S. application Ser. No. 13/038,712 which claims benefit of U.S. Provisional Application No. 61/309,740 filed Mar. 2, 2010, the entries of which are incorporated herein by reference.

### FIELD OF THE INVENTION

The present invention relates generally to methods and means for a seller of goods and/or services to enhance their business revenue opportunities through the extension of credit, and in a particular though non-limiting embodiment, to a web-enabled software package that enables the application to access a set of client-defined, purchase transaction data and product specific processing rules, computations, and validations to occur so that a pre-calibrated level of reduced risk to potential lost profits associated with an extension of credit, independent of a customer's credit-worthiness, can occur.

### BACKGROUND OF THE INVENTION

Consumers or businesses desiring to pay for a purchase of goods or services using credit must secure or have access to credit lines or limits, or an approved authorization amount adequate enough to ensure, prior to receipt or delivery of the goods or services, payment of funds to the seller equal to one hundred percent (100%) of the selling price. Credit may generally be described as a means of payment by which an authorized purchaser, subject to having or acquiring access to an approved line of credit or having authorized borrowing limits sufficient enough to cover all of the desired goods and then executing an agreement, thereby attesting to the purchaser's acceptance to honor all the agreed upon terms and conditions of the loan, credit or other financial instrument, prior to taking possession of the of goods and/or services.

There are both Federal and State based consumer credit laws, including the Federal Truth In Lending Act (“TILA”) and Regulation Z, the applicability of these Federal Laws and State Lending Laws being triggered by imposition of finance charges (e.g., interest, finance charges, service charge or time-price differential) and/or allowing payment for the goods or services to be made in installments after receipt of the goods or services purchased. Most States define an obligation to make installment payments totaling four (4) or in some States three (3) or more, in order for payment installments after taking possession or receiving the goods and/or services to constitute an extension of credit.

Credit comes in many forms, the most common of which includes financial products like credit cards, closed end installment loans, (e.g., car loans) or retail installment contract, or loan and may be secured or unsecured (e.g., credit cards are generally unsecured, car loans are usually secured—the title or ownership resides with the seller until payment-in-full occurs). The traditional methods of decision making and management of risk by the lender are based primarily upon the use of the empirical historical payment data “Credit Scoring” (e.g., a FICO Score)

Wherein an applicant's predicted future likelihood of honoring and paying future obligations is based in large measure on their historical success or failure in meeting past payment obligations. Typically, this historical payment data is accessed through various credit reporting agencies known as credit bureaus.

Credit Scores, used in combination with policies and/or other evaluations, are, in many instances, derived using complex mathematical or statistical computations and/or ratios or policy rules that predict the likelihood of default, which in turn helps to establish the criteria as to whether or not an applicant should be approved, and further, if approved, for how much credit they should be authorized to borrow.

Additionally, other considerations such as employment income, time at residence and other owned assets may be incorporated in the decision making process through ratio computations (e.g., ability-to-pay ratios like net assets to income or debt to income ratios). In short, the credit decision is in large measure based upon an “aggregate best estimate” of whether or not the applicant(s) will perform (“pay”) in the future based upon satisfaction of their past obligations.

An approved applicant (recipient of credit or debt obligor) is typically referred to using a name that is based upon the type of credit or loan instrument the applicant has established with a bank or other lender, and has chosen to use that method as the source of funds for payment obligations in a Payment Plan to be settled.

For example, a credit card approved applicant is referred to as a cardholder, or an installment loan recipient may be referred to as a loan recipient or debt obligor or a borrower.

Additionally, the maximum amount of borrowing capacity (i.e., the amount of the price of a purchase that is not paid immediately upon receipt or delivery of the goods and/or services using credit, a defined loan amount, or an amount as a future financial repayment obligation is made available for the approved applicant use to satisfy the balance due) may dictate whether or the prospective purchaser can or cannot make a purchase.

### SUMMARY OF THE INVENTION

A system and method of pre-calibrating the level of maximum risk associated with extending credit or contracting for time price differential transactions, warehousing and collecting the funds for committed payment obligations electronically, and establishing upfront a target date of eligibility for the purchaser to receive or accept delivery of goods and/or services using a prescribed and pre-authorized series of automated debits to either a banking deposit account or a credit or debit card account is disclosed herein.

The system and method uses seller pricing that offers purchase item(s) and/or service(s) priced and using comparable mark-up over cost percentages, in the same manner as goods and/or services are priced and credit offered for any other form of payment tender (i.e., credit card, debit card, retail installment contract or loan, cash, check or money order) by the seller, wherein the remaining balance being paid over time after receipt of the goods and/or services constitutes, subject to statutory provisions and law, an extension of credit or a retail sale contract or debt obligation.

The release of goods and/or performance of services is contingent upon successful receipt of funds of a cumulative amount for all system specified down payment amounts. The number and amounts of such down payments are determined based upon the seller's established proprietary profit factors; such profit factors are applied based upon individual or collective item(s) included in the purchase basket of desired (goods and services.)

This series of down payments required prior to receipt or delivery of the goods and/or services, plus a continuation of remaining payments due to satisfy the balance due after taking receipt or receiving performance of on the goods and/or services are facilitated through a onetime Payment Plan Agreement authorization that permits execution of recurring automatic withdrawals from a bank deposit account and/or subsequent credit or debit card authorized charges successfully collected for the remaining balance due upon receipt of the goods and/or services.

### BRIEF DESCRIPTION OF THE DRAWINGS

FIG. 1 illustrates an example embodiment of a method of extending an offer of credit or offer to contract for payments to an applicant in accordance with the invention.

FIG. 2 illustrates an example system that facilitates extension an offer of credit or offer to contract for payments to an applicant in accordance with the invention.

FIG. 3 illustrates an exemplary data page useful for preparing an extension of credit or offer to contract for payments to an applicant in accordance with the invention.

### DETAILED DESCRIPTION OF SEVERAL EXAMPLE EMBODIMENTS

The software solutions described herein are designed to provide increased opportunities to extend credit or offer to contract for payments at lower profit risks and costs than currently available in the payment market. In a presently preferred embodiment of the invention, the—solutions are web-based, highly scalable, and, in one exemplary embodiment, configured to cooperatively leverage the Federal Reserve's Automated Clearinghouse (hereinafter “ACH”). In another embodiment, the solution is configured to cooperatively leverage a credit or debit card processing network (hereinafter “Card Processors”).

As used herein, the term “merchandise” should be deemed to comprise either (or both) goods and services.

In various embodiments, the solutions incorporate client-specific/individual-transaction-specific business intelligence through a variably configurable, yet strictly controllable, set of system processing rules that work irrespective of the customer's credit worthiness. In a general sense, the solutions may be described as product specific payment plan agreements that enable reliable calculation of a targeted eligibility date for the receipt or delivery of goods or performance of services in conjunction with a series of structured payment obligations, so that the risk to business profit loss on a cash accounting basis is significantly reduced or eliminated entirely.

In an example embodiment, a pre-determined requisite number of payments, as well as specific amounts and payment timing obligations associated therewith, are computed in order to substantially reduce the risk of lost profits in granting credit to sub-prime/non-prime (i.e., higher-credit risk) or underbanked customers otherwise with inadequate borrowing capacity (e.g., those lacking enough credit access).

This substantial reduction of risk of loss is accomplished by defining a cohesive set of pre-authorized payments governed by an Electronic Funds Transfer and Credit Agreement or Retail Sale Contract Agreement in the case of using a deposit account or the Rules of the Card Processor in the case of using a debit or credit card, based on a plurality of predetermined profit related risk factors.

In one representative embodiment, the program comprises a structured series of“layaway type” down payments, which are then followed by a structured continuation series of subsequent post-delivery payments (after delivery of the merchandise or service), the resultant of which total the amount required to cover the remaining debt obligation out of the credit extended to permit a customer to pay for the entire purchase. Note that this structure can effectively convey a secured finance interest even in situations where there are fewer payments required than would otherwise be defined under applicable Federal or State Lending Laws as an extension of credit arrangement.

In other embodiments, the payment solutions are designed to serve qualified consumers or companies, e.g., those with a verifiable and valid form of identification or corporate authorization and an “ACH eligible” Checking, NOW, Share Draft, or Savings account in good standing at a United States chartered financial institution. In still other embodiments, the payments solutions are designed for those with a valid and verifiable credit or debit card.

In a presently preferred embodiment, the system's primary target clients are retailers or sellers of goods and services lacking the current ability to market to underbanked, or to sub-prime/non-prime credit profiled consumers (e.g., those lacking access to necessary borrowing capacity), or to businesses with liquidity or credit challenges, an attractive, yet prudent alternative to traditional time-based payment options, thereby resulting in substantial lost opportunity based revenues.

In one particular example embodiment, a customer-friendly and automated payment program accrues no interest on outstanding customer balances. In other embodiments, especially for programs associated with more expensive (or so-called “higher ticket”) items, the program does not assess charges, or allow accrual, amortization or deferment of interest. In further embodiments, the program allows customers to “stretch” their purchase power by extending payment obligations out over a longer time period in order to better accommodate low payment budget needs, provide for the extension of credit needed to complete a sale, while still substantively mitigating the risk of lost profits for the merchant or seller for that sale.

In other example embodiments, the program allows retail merchants and wholesale sellers and the like to offer structured payment plans to a substantial number of credit “turndowns” (i.e., higher risk clientele otherwise constituting underbanked and sub-prime/non-prime credit risks). In one specific embodiment, a software package is provided in which a merchant or seller uploads to the system a plurality of related predetermined profit risk factors.

One such set of arbitrary profit risk factors might include: the cost of goods to be sold; various selling, general and administrative costs specific to the seller or merchant and for the goods being sold; and their respective targeted minimum gross margin rates, which together can be integrated to compute a target delivery date for the goods and/or services being delivered to the purchaser following satisfaction of their predefined down payment obligations.

Other important transaction-level data can also be stored and maintained, for example, a a product's Stock Keeping Unit (SKU), Class and/or Department level(s) basis, for further assisting in the determination of eligibility to offer a payment plan agreement as a method of payment.

In still further embodiments, the system stores and maintains established payment amounts and payment dates for ACH transactions and presents the payments automatically to an electronic payment clearinghouse (“Federal Reserves' ACH Clearinghouse”) to “debit amounts drafted” from the customer's account according to the executed agreement after confirmation of the customer's acceptance of the seller's proposed payment terms and conditions, thereby safely and reliably facilitating satisfactory remission and collections of payment proceeds to the merchant or seller.

According to various other embodiments, the structure of a payment product plan comprises a series of bifurcated structured electronic funds transfer payments that represent: (1) the “amortized payments” equal to a minimum targeted down payment amount (i.e., a sub-set of the overall series of authorized plan payments) required to ensure that the merchant or seller's predefined economic parameters are satisfied prior to the customer's notification of eligibility to pickup or receive the merchandise or services; and (2) all remaining “amortized payments” equal to the customer's remaining payment obligations to the merchant or seller in order to satisfy the Electronic Funds Transfer and Credit Agreement or the Pre-Authorized Credit Card or Debit Agreement, the totality of the remaining payments after the down payments representing the remaining maximum profit margin potential for the goods or services sold by the merchant.

In another embodiment, the system and methods allow the seller or merchant to prescribe the number and frequency of payments (e.g. weekly, bi-monthly, twice-a-month or monthly) being offered to the applicant as an option for selection and use in computing the required payment amounts. The embodiment allows various additional rules in establishing proposed dates of payments for the applicant to choose or confirm; examples include the day of the week or day(s) of the month (1-28), or day of the week (Monday-Sunday) and week of month (e.g. Week 1 through Week 4) to incorporate into the proposed Payment Plan Agreement.

In other embodiments, the software package comprises means for storage and retrieval of necessary “targeted” maximum profit risk or minimum profit factor parameters, permitting optimization for any merchandise at any transaction level, and in any event consistent with the merchant or seller's system risk and business processes configuration decisions, as well as data and means for determining the amortization of balances owed in association with payment amounts for the down payment series and the remaining payment series that will be due after receipt of the goods and services.

Those of ordinary skill in the pertinent arts will appreciate that the underlying business rationale for these proprietary percentages is that by ensuring all ([cost of goods sold]+[out-of-pocket expenses]+[minimum target level of guaranteed gross margins]) amounts have been secured prior to the release of merchandise, the merchant or seller is guaranteed, under compliant non-fraud transactions, it will incur no lost profit or opportunity cost, even in an the event of a default after receipt or delivery of the goods and/or services by the customer. Similarly, all computed payments are “warehoused” and presented to the planholder's elected channel of payment settlement network (i.e., ACH Clearinghouse, Credit Card or Debit Card Network) so that funds may be transferred directly from the customer's bank, credit or debit account in accordance with the agreed upon effective dates of each payment.

In another example embodiment, the seller or merchant, subject to any commercial agreement to the contrary that provides for transference of a portion or all of the seller's risk, in exchange for fees, bears all the risks associated with the credit extension or contractual loan or debt amounts. Since the merchant or seller predefines and configures its own risk and profit factors, the provider of the service described herein is relieved of any obligation to monitor or investigate shortfalls in expected merchant profits, except to the extent that such matters have allegedly resulted from a system failure of some nature. In a further example embodiment, the seller or merchant has an option, subject to the provisions of defined terms of the Merchant Services Agreement between the provider of the service, and the assignee bears all the risk of collections in the event a defined pre-authorized payment is determined to be uncollectable in exchange for increased processing fees.

In one example embodiment of the invention, a purchaser may select the method by which they would like to elect from the options offered, and under the contract terms and conditions, for their pre-authorized recurring automatic debits to be collected. One of three prescribed methods may be selected and used by the system's electronic funds transfer processes. One method is via electronic funds transfers using a debit to a demand deposit account. A second method would be to charge an authorized credit card with an adequate credit line or limit. Finally, a PIN or PIN-less debit to a deposit account may be used in initiating the request for payment of funds for authorized payment amounts. Specifically, as a detailed example of one method of collecting the funds is through an automatic electronic funds transfer withdrawal by way of initiating a debit to a bank deposit account through the Automated Clearing House 20 Network.

The Automated Clearing House Network is a batch-oriented, electronic funds transfer system that is governed by the National Automated Clearing House Association (NACHA) operating rules and regulations. These rules and regulations set forth an interbank electronic payment and clearing system for participating depository financial institutions. The Federal Reserve Bank and others like the Electronic Payment Network for instance, serve as Automated Clearing House operators. These operators serve as the central facilities through with participating institutions may transmit and received Automated Clearing House entries.

There are various forms and parties to Automated Clearing House; parties to these transactions including consumer to business, business to business, business to consumer and government. The various forms of transactions are defined by NACHA operating rules as the Standard Entry Class (SEC) codes for a particular authorized transaction, including direct deposit transactions, pre-authorized recurring payment debits, world wide web initiated payment requests, corporate disbursement account debits, phone authorized debits, account receivable conversion, check truncation etc.

Any individual, corporation, or other entity that initiates an authorized entry into the Automated Clearing House Network, whether it is deposit (credit) entry, or withdrawal (debit) entry, is considered to be an Originator. Any participating depository financial institution authorized by the Federal Reserve Bank to originate Automated Clearing House entries on behalf of an originator who has secured an authorization request by a deposit account holder is considered to be an Originating Depository Financial Institution (ODFI). Any individual, corporation, or other entity that authorizes an originator to initiate credit or debit entry(s) to their depository account (i.e. receive a transaction amount) residing at a depository financial institution is considered to be the receiver of the transaction. Depository Financial Institutions where the depository account resides is considered the Receiving Depository Financial Institution (RDFI).

In another embodiment of the invention, the system allows configuration of certain automated handling features for returned unpaid debit item(s). The system offers several business rules options for selection, each representing the specific rules to use on returned unpaid items via an automated re-presentment and/or recreation of the original ACH origination item as permitted under NACHA Operating Rules and Guidelines, in a NACHA ready file format, for insufficient or uncollected funds based returns as well as other reasons for ACH based payments returned unpaid. The system's auto handling features include the uploading of an automated NACHA formatted returns file received from the ODFI or ODFI's ACH operator. The NACHA return codes are configured to facilitate mapping of return items into work queues that systematically track the contents of the Automated Clearing House network return record, pertinent information returned from the RDFI as to what reason is given for the nature of the return unpaid item, and insight into the method(s), timing and/or correction of banking information to resolve any related errors or omissions and re-presentment or re-initiation of the unpaid returned item.

Another example of collecting funds using the chosen method of automatic payments would include initiating authorizations for each authorized Payment Plan Agreement payment using an authorized charge to a valid credit card through a credit card processing network and then subsequent submittal of the authorized amount and required authorization and settlement data to the processor for monetary settlement, wherein the authorized transaction is posted as a debit against the cardholders account.

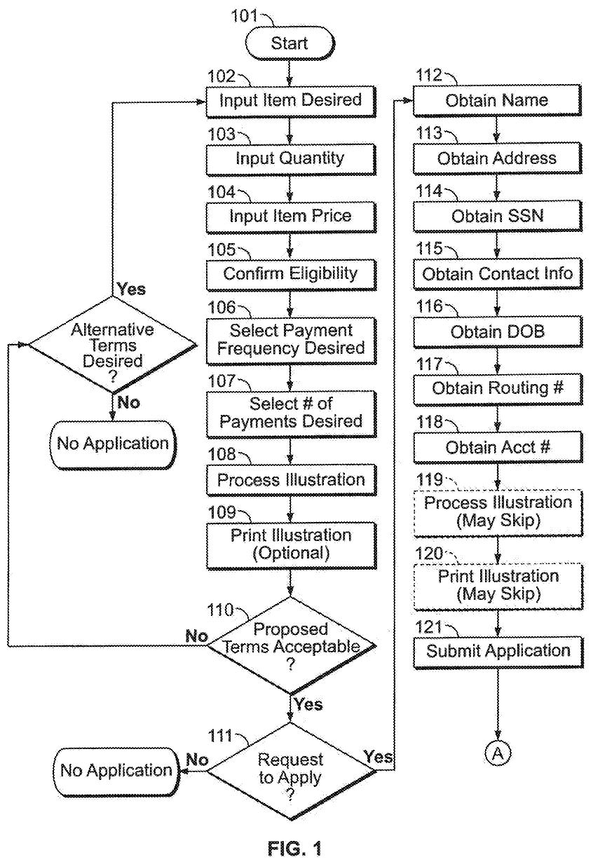

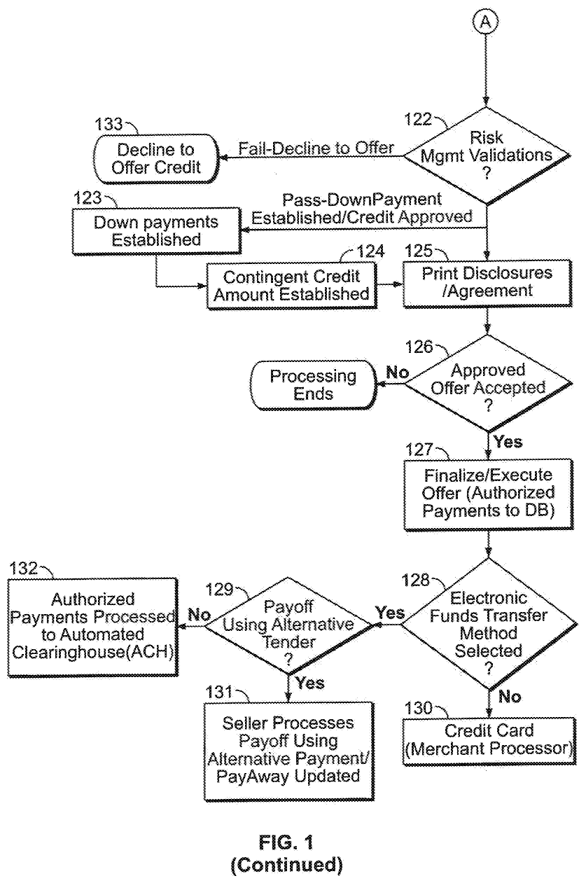

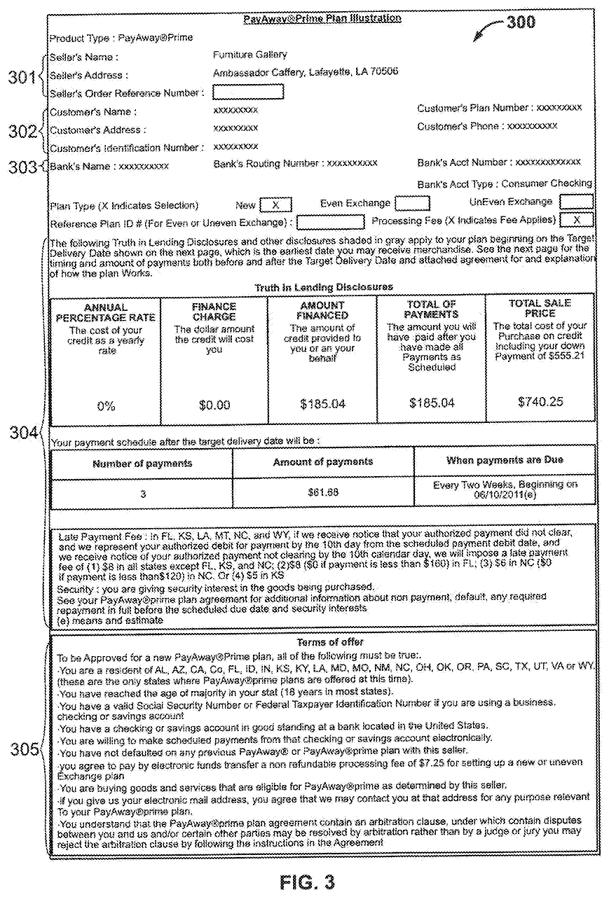

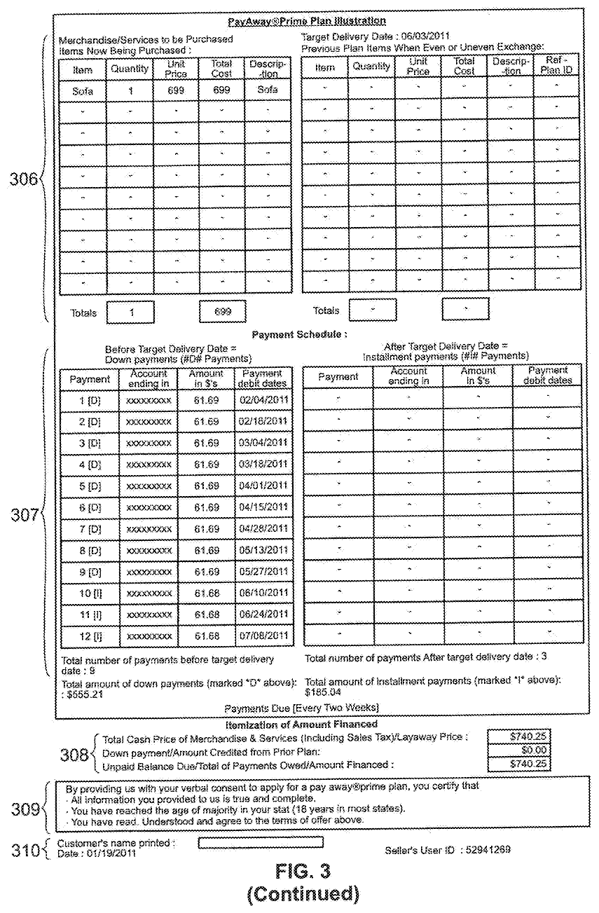

Turning now to FIG. 1, a solution illustrating a flexible and variable term structure is provided wherein the method comprises an extension of credit to an applicant desiring alternative payment terms in order to pay for particular goods or services. At step 101, the seller receives a request for alternative payment terms. At steps 102 to 104, the applicant submits and the seller receives information specific to the merchandise that the applicant wishes to purchase, including the item and quantity desired and the unit price. At decision 105, the seller verifies whether the desired merchandise is eligible for alternative payment terms. Next, at steps 106 and 107, the seller receives the chosen payment frequency and total number of payments from those offered, as desired by the applicant. Next, at step 108, the seller displays the process illustration, as more fully described in FIG. 3. At step 109, the applicant will have the option of printing the process illustration.

At decision 110, the seller presents and verifies whether the proposed terms are acceptable to the applicant or whether an additional iteration for alternative proposed terms to be presented is desired, and at 111, whether the applicant would like to proceed with formally applying for the then presented alternative payment terms. If the applicant responds in the affirmative, the applicant enters and the seller receives the applicant's personal data at steps 112 to 116, including name, address, social security number, contact information, and date of birth.

Then at steps 117 and 118, the applicant enters their credit card, debit card, or deposit account information. At steps 119 and 120, the applicant has the option of viewing and receiving a printed copy of the proposed payment terms and amounts from the seller via the process illustration. At step 121, the applicant submits and the seller receives the completed application. At step 122, the seller runs a series of calculations and applicant validations using a plurality of pre-determined, profit and identity related risk factors, in order to determine whether or not to offer terms. The seller may decline to offer terms for suspected fraud, previous issues with the seller, or because of an inability to authenticate the applicant's identity or provided personal account information, as shown at step 133. If the seller determines that an offer of terms should be extended, at steps 123 and 124, the down payment amount (the amount that must be paid prior to receiving the goods and/or services requested) and contingent credit, debt or loan amount as applicable by Federal and/or State Lending laws is established. At step 125, the seller displays to the applicant the proposed credit, debt or loan agreement, including any required disclosures, with the option of printing.

If the applicant accepts the offer at step 126, step 127 reflects the seller's instructions to the system to finalize and write (i.e. warehouse) the terms to the systems database. Step 128 reflects the system's extraction and “just in time” presentment of each pre-authorized debit, in accordance with the specified transfer method in the executed agreement, or as modified by the system based upon seller input of a purchases request to modify, all required account and authorization related information, amount, and effective date of each individual payment If the approved applicant selected the Electronic Funds Transfer using the ACH network transfer method at step 127, and it is not a Payoff using an Alternative Tender, the seller transmits the authorized debit to the ACH Clearinghouse, else if the approved applicant selected a credit or debit card as the method of transfer, and the payment is not a Payoff using an alternative tender, the debit is sent to the merchant processor 130. If the approved applicant desires to payoff the goods and/or services using alternative tender, the seller processes the payoff using alternative payment 131. Otherwise, the authorized payments are processed in the ordinary manner 132.

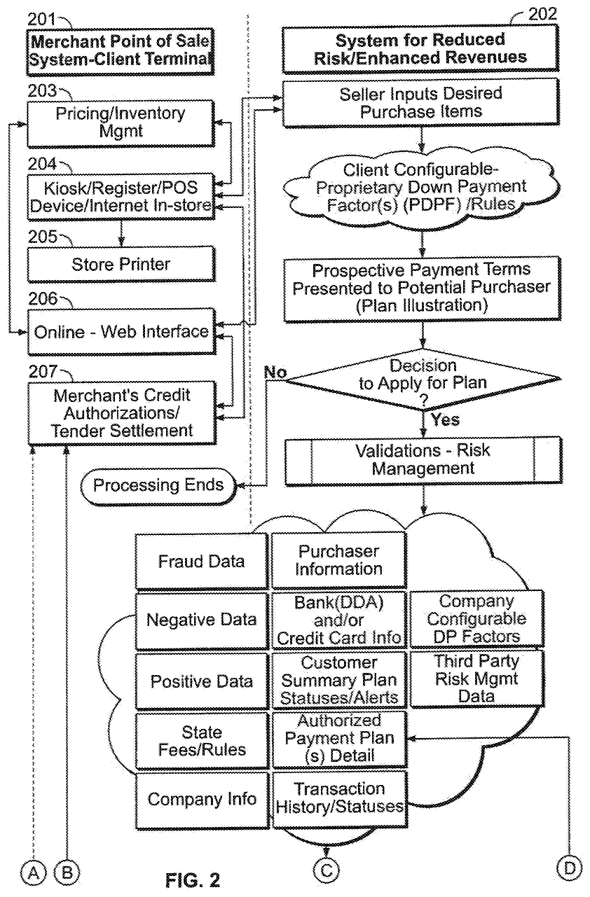

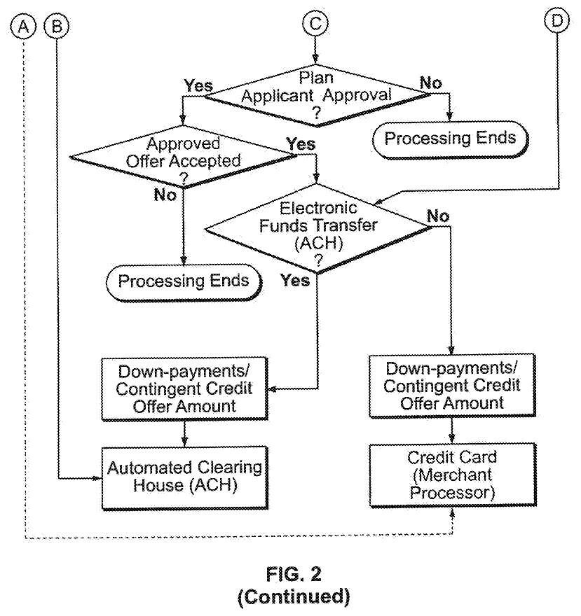

Turning now to FIG. 2, illustrated therein is one embodiment of a system 200 for an extension of credit to an applicant desirous of alternative payment terms. The system includes a client-side terminal 201 configured to communicate with an extension of credit server 202. The client-side terminal 201 may include kiosks, registers, point-of-sale devices, or other devices 204 for facilitating the application process for possible extension of credit to interested applicants. The client-side terminal further incudes the seller's pricing and inventory information 203.

The application adjudication process, risk reduction factors and interfaces to data necessary to compute the pre-calibrated level of reduced risk of maximum potential lost profits associated with the offered terms for extension of credit, debit financing or loan, occurs using the system database(s) accessed through server(s) 202. Once receiving the required applicant and merchandise/services information from the client-side terminal 201, server(s) 202 completes the method for determining whether or not an extension of credit will occur, as more fully described in FIG. 1. The extension of credit server delivers browser readable content to the client terminal 201 through an online-web interface 206. The device for facilitating the execution of related agreements to memorialize an accepted offer of extension of credit is connected to a store printer 205.

Turning now to FIG. 3, illustrated therein is one embodiment of the process of an offer of credit using the ACH Clearinghouse as the chosen method of debit funds settlement is contained in illustration 300, illustrating of the specific terms of an individual offer of credit to the applicant. At 301, the seller's information, including name, address, and order reference number, is displayed. At 302, the applicant's inputted personal information is displayed, including name, address, plan number, and telephone number. At 303, the applicant's bank information is displayed, including the bank's name and routing number and the applicant's account number and account type. At 304, any required statutory Truth In Lending Disclosures are displayed. At 305, the terms of the offer are displayed. The merchandise to be purchased, including the description, quantity, unit price, and total cost, is displayed at 306. The payment schedule 307 is displayed, showing the payments to be made before the Target Delivery Date, the total dollar amount of down payments, the total number of payments after the Target Delivery Date, and the total dollar amount of the required installment payments. The itemization of the amount financed is displayed at 308. Necessary certifications are provided at 309, and the applicant's authorization is displayed at 310.

The foregoing detailed description is intended primarily for illustrative purposes, and is not intended to include all possible aspects of the present invention. Moreover, while the invention has been shown and described with respect to an exemplary embodiment, those of skill in the pertinent arts should appreciate that the foregoing detailed description, and various other modifications, omissions and additions, so long as in the general form and detail thereof, may be made without departing from either the spirit or scope of the present invention.

1. A computer enabled business method for executing a reduced-risk extension of credit system that relies on variable and scalable profit- and risk-based credit extension decision criteria but excludes consideration of an applicant's credit score, said business method carried out on a computer system, said computer system comprising one or more processors and one or more non-transitory computer-readable media having stored thereon executable instructions such that when executed by the one or more processors configures the computer system to perform at least the following steps:
receiving a request from an applicant to obtain alternative financing in order to purchase merchandise and approving said alternative financing request irrespective of applicant's credit score worthiness, said request being digitally converted to digital data and stored on said computer readable media;
calculating an offer of credit based upon a plurality of seller's established goods and services profit and risk management factors in order to establish a plurality of credit extension decision criteria, said offer of credit comprising a repayment amount, said repayment amount comprising at least one down payment amount and a remaining balance, said at least one down payment amount representing a fraction of the repayment amount to be collected prior to an applicant's receipt or seller's delivery to a buyer of the merchandise, wherein said plurality of profit- and risk-based credit extension decision criteria are predefined and digitally stored on said computer readable media, whereas the plurality of credit extension decision criteria is used dynamically to make an actual credit extension decision for extending an offer of credit and without further input being required or obtained from a seller in response to the request;
establishing a merchandise release date based on successful collection of said at least one down payment amount in accordance with terms and conditions associated with the offer of credit and extending the offer of credit to the applicant, and storing the established merchandise release date on said computer readable media;
confirming collection of a pre-authorized repayment amount that includes at least one down payment amount collected through an electronic debit following the applicant's acceptance of the offer of credit, and storing data on said computer readable media affirmatively indicative of collection of said at least one down payment and an entire repayment amount;
releasing the merchandise upon successful receipt of the at least one down payment amount, thereby causing physical merchandise to leave possession of a user or agent thereof and be released to the applicant, and then storing data on said computer readable medium affirmatively indicative of the release of some or all of the merchandise; and
collecting a remaining repayment amount following the release of said one or more of goods and services included under a sale agreement, and storing data on said computer readable medium affirmatively indicative of both a progress of repayment and completion of repayment.

2. The computer enabled business method of claim 1, wherein the electronic funds transfer step further comprises computing, entering and storing withdrawal entries through the automated clearinghouse or credit processing network from deposited funds or available credit on hand for an account, and then storing data on said computer readable medium affirmatively indicative of the same.

3. The computer enabled business method of claim 2, further comprising collecting funds held in a deposit account by a receiving depository financial institution, and then storing data on said computer readable medium affirmatively indicative of the same.

4. The computer enabled business method of claim 1, wherein the electronic funds transfer step further comprises settling an authorized charge to a credit card account through a credit card processing network, and initiating said electronic funds transfer as a debit against the credit card account, and then storing data on said computer readable medium affirmatively indicative of the same.

5. The computer enabled business method of claim 1, wherein the electronic funds transfer step further comprises settling an authorized charge charged to a debit card account through a debit card processing network, and said electronic funds transfer comprising a debit against the debit card account, and then storing data on said computer readable medium affirmatively indicative of the same.

6. The computer enabled business method of claim 1, further comprising prescribing a targeted maximum dollars at risk as a risk management factor, and then storing data on said computer readable medium affirmatively indicative of the same.

7. A computerized system for enabling a customer to purchase merchandise from a seller as part of a transaction, wherein the transaction has a total purchase price configured to be paid in full over time using a plurality of prescribed partial payments, wherein the merchandise is released to the customer on a targeted release date scheduled prior to payment of the total purchase price, the system comprising:
a customer device having a customer user interface;
a seller device having a seller user interface;
one or more payment sources of the customer;
one or more transaction processing interfaces; and
a transaction processing server in electronic communication with the customer device, the seller device, and the one or more payment sources of the customer, the transaction processing server comprising: one or more processors, a memory storage, data storage, and a non-transitory computer readable medium that is usable by the one or more processors and is operatively coupled to the memory storage and the data storage, the computer readable medium having stored thereon a sequence of instructions that, when executed by the one or more processors, causes the execution of the steps of:
receiving, by the one or more processors, from the seller device a list of merchandise and storing the list of merchandise within the data storage, the list of merchandise identifying a plurality of respective merchandise available for purchase by the customer,
the seller to select and associate in advance, using the seller user interface, one or more of a plurality of profit risk factors with each of the plurality of respective merchandise each of the one or more of the plurality of profit risk factors having a combination or permutation of configurable numeric values selectable by the seller;
receiving from the seller device and storing, in the data storage, the one or more of the plurality of selected profit risk factors and corresponding numeric values associated with each of the plurality of respective merchandise;
receiving, by the one or more processors, from the customer user interface as part of a specific transaction, a request to purchase at least one of the plurality of respective merchandise for the total purchase price;
based on the at least one of the plurality of respective merchandise identified in the request and based on the one or more of the plurality of selected profit risk factors and corresponding numeric values previously selected and stored in the data storage and associated with at least one of the plurality of respective merchandise identified in the request, dynamically determining, within the one or more processors, and without further approval or conditions being obtained from the seller or the seller device in response to the request:
(i) a cash value portion of the total purchase price the seller is not willing to put at risk for the specific transaction; and
(ii) one or more proposed payment plans, each of the one or more proposed payment plans identifying: (a) a proposed payment schedule for the customer to complete payment of the total purchase price over a predetermined period of time, (b) payment dates and payment amounts for each of the plurality of prescribed partial payments to be made during the predetermined period of time, and (c) the targeted release date, wherein the targeted release date is scheduled prior to full payment of the total purchase price and based on receipt of a sufficient number of prescribed partial payments to cover the cash value portion of the total purchase price;
offering, using the customer user interface in communication with the one or more processors, the one or more proposed payment plans to the customer and receiving acceptance, via the customer user interface, from the customer of one of the one or more proposed payment plans as an agreed-upon payment plan, the acceptance including identification and confirmation by the customer of the one or more pre-approved payment sources from which the seller is authorized to draw against for each of a plurality of agreed-upon payment amounts on its respective payment date;
and thereafter, electronically presenting, by the one or more processors, each of the plurality of agreed-upon payment amounts, on its respective payment date, for payment from the one or more pre-approved payment sources;
upon confirming successful representment, settlement, and posting, by the one or more processors, of all of the plurality of agreed-upon payment amounts having respective payment dates prior to the targeted release date, authorizing transfer to the customer of the respective merchandise identified in the agreed-upon payment plan, which effectuates physical transfer of the respective merchandise to the customer; and, thereafter,
confirming, by the one or more processors, successful representment, settlement, and posting of each of the plurality of agreed-upon payment amounts having respective payment dates after the targeted release date, which effectuates transfer of ownership of the respective merchandise to the customer.

8. The system for enabling a customer to purchase merchandise of claim 16, wherein the merchandise comprises one or more goods, products, or services.

9. The system for enabling a customer to purchase merchandise of claim 16, wherein the seller comprises one or more of a retail merchant, a wholesaler, a service provider, a processor, a manufacturer of the merchandise, a provider of the merchandise, a creator of the merchandise, an operator of the computerized system, a payment guarantor, or an authorized agent or reseller of the merchandise.

10. The system for enabling a customer to purchase merchandise of claim 16, wherein each of the one or more proposed payment plans and corresponding targeted release dates is dynamically determined without use of third party payment history or credit bureau information used to score or determine the customer's credit worthiness.

11. The system for enabling a customer to purchase merchandise of claim 16, wherein each of the plurality of agreed-upon payment amounts having its respective payment date prior to the targeted release date comprises one or more down payments and each of the plurality of agreed-upon payment amounts having its respective payment date after the targeted release date comprises one or more installment payments and wherein the targeted release date is scheduled to occur after successful representment, settlement, and posting of the one or more down payments and prior to successful representment, settlement, and posting of the one or more installment payments.

12. The system for enabling a customer to purchase merchandise of claim 16, wherein the down payments are calculated to be sufficient to cover the cash value portion of the total purchase price the seller is not willing to put at risk for the specific transaction.

13. The system for enabling a customer to purchase merchandise of claim 16, wherein authorizing transfer to the customer of the respective merchandise identified in the request occurs upon successful representment, settlement, and posting of the full amount of the down payment.

14. The system for enabling a customer to purchase merchandise of claim 16, wherein the transfer of the respective merchandise identified in the request comprises physical delivery of the respective merchandise, shipment to the customer of the respective merchandise, authorization for the seller to initiate provision of services to the customer, or actual provision of services by the seller to the customer.

15. The system for enabling a customer to purchase merchandise of claim 16, wherein each of the plurality of agreed-upon payment amounts are identical amounts.

16. The system for enabling a customer to purchase merchandise of claim 16, wherein each of the plurality of agreed-upon payment amounts are different amounts.

17. The system for enabling a customer to purchase merchandise of claim 16, wherein the step of electronically presenting each of the plurality of agreed-upon payment amounts for draw against the one or more pre-approved payment sources comprises initiating an automated clearinghouse (ACH) electronic fund transfer or initiating an electronic fund transfer from a debit account, a credit account, or a pre-paid card provided by the customer.

18. The system for enabling a customer to purchase merchandise of claim 16, wherein the plurality of profit risk factors selectable by the seller for association with each of the respective merchandise includes one or more of: the cost basis of the respective merchandise, seller's total costs of goods sold associated with the respective merchandise, seller's out of pocket expenses associated with the respective merchandise, seller's commission costs associated with the respective merchandise, seller's administrative costs associated with the respective merchandise, seller's targeted minimum gross margin rate associated with the respective merchandise, a minimum purchase amount for the transaction, a maximum purchase amount for the transaction, and a number and frequency of payments the seller is willing to accept for the transaction.

19. The system for enabling a customer to purchase merchandise of claim 16, further comprising receiving from the seller and storing, within the data storage, one or more of: seller's location, channels of sale, physical location, a stock keeping unit (SKU), a class of merchandise level basis, and a company-wide, region, division, or department level basis associated with each of the respective merchandise.

20. The system for enabling a customer to purchase merchandise of claim 16, further comprising converting the agreed-upon payment plan into a formal contract executed by the customer and the seller and storing a digital copy of the formal contract and its terms in the data storage.

21. The system for enabling a customer to purchase merchandise of claim 16, wherein the numeric values for the one or more of the plurality of selected profit risk factors is received from the seller and stored, within the data storage, using one or more of: a scheduled batch upload, a real-time advanced programming interface (API) update, and a manual input.

22. The system for enabling a customer to purchase merchandise of claim 16, further comprising modifying the agreed-upon payment plan or the targeted release date based on additional information obtained prior to or during the predetermined period of time of the agreed-upon payment plan, wherein the additional information includes one or more of: income data associated with the customer, calculation of a predetermined ratio between customer's income and the periodic payment amounts, authentication of customer's identity, authentication of customer's one or more payment sources, customer's compliance with terms and conditions of the agreed-upon payment plan, rejection, representment, or resolving delinquency of receiving one or more of the plurality of agreed-upon payment amounts, detection of fraudulent or potentially fraudulent information provided by or discovered about the customer, and receiving a subsequent request from the customer to purchase one or more additional merchandise.

23. The system for enabling a customer to purchase merchandise of claim 16, further comprising receiving one or more of a requested period of time, requested payment dates, and requested payment amounts from the customer as part of the request, and wherein the one or more proposed payment plans are dynamically determined within the one or more processors based at least in part on the requested period of time, requested payment dates, and requested payment amounts received from the customer in the request.

24. The system for enabling a customer to purchase merchandise of claim 16, wherein the cash value portion of the total purchase price and the one or more proposed payment plans are dynamically determined by the one or more processors using an n-tiered decision tree engine that takes into consideration the one or more of the plurality of selected profit risk factors and corresponding numeric values previously selected and associated by the seller and stored in the data storage with the transaction and with at least one of the plurality of respective merchandise identified in the request.

25. The system for enabling a customer to purchase merchandise of claim 16, wherein the total purchase price is the actual price of the merchandise whether paid in full at time of the transaction or whether paid over the predetermined period of time of the agreed-upon payment plan.
